(19) United States
(12) Patent Application Publication
(10) Pub. No.: US 2015/0289959 A1
(43) Pub. Date: Oct. 15, 2015

(54) Electric Rotary Brush

(71) Applicant: Gary Bronikowski, Duluth, MN (US)

(72) Inventor: Gary Bronikowski, Duluth, MN (US)

(21) Appl. No.: 14/682,485

(22) Filed: Apr. 9, 2015

Related U.S. Application Data
(60) Provisional application No. 61/977,708, filed on Apr. 10, 2014.

(51) Int. Cl. A61C 17/26; A61C 17/22

(52) U.S. Cl. CPC A61C 17/26; A61C 17/222

(57) ABSTRACT

An electric rotary toothbrush is provided. The electric rotary toothbrush includes a housing with an electric motor located within the housing. The electric motor drives a power rod to provide a rotational force to a rotary brush head. The power rod is located in a shaft portion that extends from the housing. The first end of the shaft comprises a curved tubular neck portion that tapers to a curved edge portion. The second end of the shaft is removably mounted on the housing. A rotary brush head is rotatably mounted on the curved tubular neck portion of the first end of the shaft. The rotary brush head includes a ring and pinion gear assembly. The pinion gear is coupled to the power rod and drives the annular ring in an end over end motion. The annular ring has bristles extending radially from the periphery of the annular ring.

### CROSS REFERENCE TO RELATED APPLICATION

This application claims the benefit of U.S. Provisional Application No. 61/977,708 filed on Apr. 10, 2014. The above identified patent application is herein incorporated by reference in its entirety to provide continuity of disclosure.

### FIELD OF THE INVENTION

The present invention generally relates to an electric toothbrush. More specifically, the present invention relates to an electric rotary toothbrush including a rotary brush head with a ring and pinion gear assembly adapted to brush in an end over end motion away from a user's gum line.

### BACKGROUND OF THE INVENTION

Proper and correct dental hygiene by tooth brushing is an essential way to maintain oral cavity hygiene and health. One of recommended tooth brushing methods is to clean teeth by moving a brush from the gum of teeth to the edge of the teeth while the brush is held in position on the gum. However, brushing teeth in this manner is time consuming and repeating the regular actions can be inconvenient.

In order to more easily clean teeth in the above described manner, many people use electrical toothbrushes. A conventional electric toothbrush may incorporate a brush section that couples to a handle section. A drive shaft may extend from the handle section with the drive shaft being coupled to an electric drive disposed within an interior of the handle section. The brush section can couple and secure to the handle section with the drive shaft coupling to a coupling element of the brush section, e.g., a shaft or drive pin. The motion of the drive shaft can be imparted upon the coupling element to provide a desired cleaning action to a rotary brush head portion of the brush section.

A common arrangement for a brush section includes a substantially circular rotary brush head portion. The rotary brush head is caused, by action of the electric drive, to have a spin or spin-oscillating motion, i.e., cleaning motion during cleaning use. The circular rotary brush head design combined with the cleaning motion is effective for cleaning teeth and is optimal when a tooth-by-tooth cleaning pattern is used. Still, many consumers enjoy taking a proactive role in their oral hygiene activity. At times, the user will use the electric toothbrush with a manual brushing action, e.g., using vertical or circular strokes. For the electric toothbrush having a circular rotary brush head design and employing a spin or spin-oscillating cleaning motion, using this electric toothbrush with a manual brushing action can be counter-productive and may reduce the effectiveness of the rotary brush head design and cleaning action. The electric toothbrush is rendered less effective while the consumer erroneously believes the added action makes for a more effective and/or expedited cleaning process.

Although electric toothbrushes provide a more thorough cleaning than regular toothbrushes, electric toothbrushes are limited due to their spin brush head design. Existing electric toothbrushes contain a spin brush head that operates in a front-facing spin fashion that does not completely clean a user's teeth and gums. The placement of the bristle head on existing electric toothbrushes does not allow the user to maneuver the bristle in upward strokes. Therefore, there is a need for an electric toothbrush with an improved rotary brush head in which a user can brush his or her teeth with upward brush strokes so that the brush is moving away from the user's gums.

### SUMMARY OF THE INVENTION

In view of the foregoing disadvantages inherent in the known types of spin brush heads for electric toothbrushes now present in the prior art, the present invention provides an electric rotary toothbrush wherein the same can be utilized for providing convenience for the user when brushing teeth away from a user's gum line.

Therefore, it is an object of the present invention to provide an electric rotary toothbrush including a housing. The housing includes an electric motor located within the housing. The electric rotary toothbrush further includes a shaft portion extending from the housing, having a first end and a second end. The first end comprises a curved tubular neck portion that tapers to a curved edge. The second end is removably mounted on the housing.

It is one object of the present invention to provide an electric rotary toothbrush including a rotary brush head rotatably mounted on the curved tubular neck portion of first end of the shaft. The rotary brush head comprises a ring and pinion gear assembly. The annular ring comprises a cylindrical structure having bristles extending radially therefrom. The annular ring promotes an end over end rotation of the bristles rather than a circular rotation of the bristles.

It is another object of the present invention to provide an electric rotary toothbrush wherein the rotary brush head further comprises a rear gum guard. The rotary brush head is rotatable via a pinion. The annular ring and pinion may be removably attached to the first end of the shaft.

It is yet another object of the present invention to provide an electric rotary toothbrush wherein the electric motor provides three different speed settings. The speed settings are preferably between 100 and 500 revolutions per minute. In one embodiment, the electric motor may be powered by rechargeable batteries.

It is yet a further object of the present invention to provide an electric rotary toothbrush further including an activation switch configured to turn the electric motor on or off.

Another object of the present invention is to provide an electric rotary toothbrush wherein the rotary brush head can pivot 90 degrees about the shaft. The rotary brush head rotates about an axis perpendicular to the shaft of the electric rotary brush. The rotary brush head bristles spin in a forward direction and revolve around the annular ring.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of the electric rotary toothbrush according to one embodiment of the present invention.

FIG. 2 shows a cross-sectional view of the electric rotary toothbrush according to one embodiment of the present invention.

FIG. 3 shows a side view of the electric rotary toothbrush according to one embodiment of the present invention.

### DETAILED DESCRIPTION OF THE INVENTION

Reference is made herein to the attached drawings. Like reference numerals are used throughout the drawings to depict like or similar elements of the electric rotary toothbrush. For the purposes of presenting a brief and clear description of the present invention, the preferred embodiment will be discussed as used for brushing teeth. The figures are intended for representative purposes only and should not be considered to be limiting in any respect.

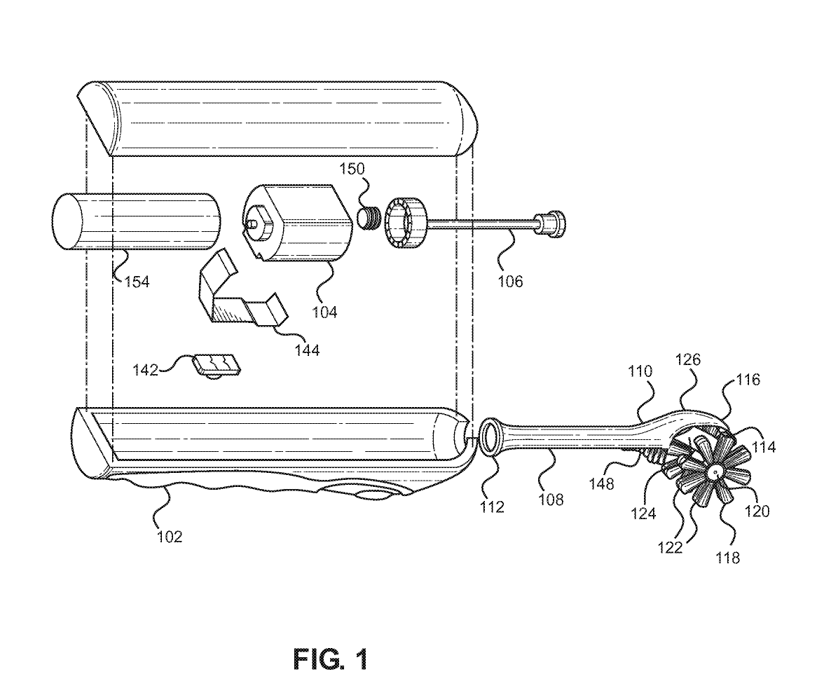

Referring now to FIG. 1, there is shown an exploded view of the electric rotary toothbrush according to one embodiment of the present invention. In the electric rotary toothbrush of FIG. 1, a power rod 106 is operatively connected to an electric motor 104 located in the housing 102. The electric motor 104 provides rotational force to a power rod 106. The power rod 106 rotates, spins, swivels, oscillates or reciprocates about an axis approximately normal to the longitudinal axis of the rotary brush head 118. The electric motor 104 provides at least three different speed settings to the rotary brush head 118. The speed settings of the electric motor 104 are preferably in a range of 100 to 500 revolutions per minute. In one embodiment, a user can operate the electric rotary toothbrush by depressing an actuator button 142 which places a metal contact 144 in between a battery 154 and the electric motor 104. In this way, the power rod 106 receives a rotational motion from the electric motor 104 via a spindle 150.

A shaft portion 108 extends vertically from the housing 102. The shaft portion 108 has a first end 110 and a second end 112. The first end 110 is operably connected to the power rod 106 and the second end 112 is removably mounted on the housing 102. The first end 110 comprises a curved tubular neck portion 114 that tapers to a curved edge 116. The curved edge 116 is rounded and serves as a rear gum guard. The shaft 108 includes static bristles 148 extending horizontally from the first end 110 of the shaft 108. The first end 110 provides a curved tubular neck portion to allow a rotary brush head 118 to be mounted in an upward, forward facing direction. The power rod 106 is coupled to the rotary brush head 106 to provide a rotational force. This promotes the bristles 122 of the rotary brush head 118 to spin in a forward direction as opposed to a circular direction of many conventional electric toothbrushes.

A rotary brush head 118 is rotatably mounted on the first end 110 of the shaft 108 via a ring and pinion gear assembly. The pinion gear 124 is operably connected to the power shaft 106. The pinion 124 is the gear that delivers the power from the electric motor 104 which is carried by the power shaft 106 to the ring and pinion gear assembly. The pinion 124 includes machined grooves that fit into mating grooves of the ring 120 gear run along the outside edges. The ring 120 sits at a full 90-degree angle to its mate, the pinion gear. The ring 120 is configured to provide an end over end motion for a plurality of bristles extending therefrom.

In one embodiment, the rotary brush head 118 comprises an annular ring 120 having bristles 122 extending radially around a periphery of the annular ring 120. The bristles 122 are evenly spaced around the periphery of the annular ring 120. In a preferred embodiment, the rotary brush head 118 further includes a rear gum guard 126. The pinion 124 upwardly tilts the rotary brush head 118 at a predetermined angle. The rotary brush head 118 is rotatable via the pinion 124. The pinion 124 may be removably attached to the first end 110 of the shaft 108. This way, the rotary brush head 118 may be replaced as needed.

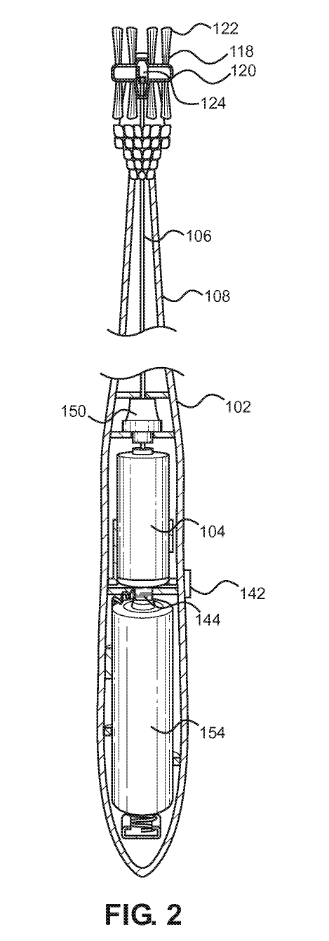

Referring now to FIG. 2, there is shown a cross-sectional view of the electric rotary toothbrush according to one embodiment of the present invention. In the electric rotary toothbrush of FIG. 2, the housing 102 may further include an activation switch 142 operably connected to the electric motor 104. The activation switch 142 includes an actuator button and a metal contact 144. The activation switch 142 is manually operated by pressing the actuator button down, which then presses against a metal contact 144, completes the circuit and provides momentary operation of the toothbrush.

The activation switch 142 may also allow continuous operation through a ramp design, sliding the forward toward the head to provide for continuous operation. Moving the actuator button forward, combined with a molded in ramp in the metal contact, causes the actuator button to move downward, pressing against the metal contact and completing the circuit. The toothbrush then continuously operates until the actuator button is slid back into an off position toward the handle and the actuator button disengages the metal contact.

In one embodiment, the electric motor 104 is coupled to the activator switch and is powered by rechargeable batteries. The electric motor 104 provides power to the power rod 106. The electric motor 104 provides power to the power rod 106 to rotate, spin, oscillate, or reciprocate. The activation switch coupled to the electric motor 104 is configured to turn the electric motor 104 on or off. In one embodiment, the activation switch 142 may also adjust the speed settings of the electric motor 104.

The rotary brush head 118 can pivot 90 degrees about the shaft 108 as shown in FIG. 2. When the rotary brush head 118 is tilted in a 90 degree angle, the rotary brush head 118 is parallel with the shaft 108. In the parallel configuration, the rotary brush head 118 can come in contact with teeth at different angles. In a preferred embodiment, the electric rotary toothbrush further includes a forward and reverse switch to adjust the angle of the rotary brush head 118.

In another embodiment, the rotary brush head 118 has an annular ring 120 having a top surface and a bottom surface. Bristles 122 may extend radially from the top surface and bottom surface, forming a cylindrical shape. The rotary brush head 118 spins in a forward direction away from a user's gum line. The annular ring 120, forming the body of the rotary brush head 118, is adapted to spin in an upward fashion, cleaning the teeth and gums of the user. The rotary brush head spins in a manner that enables an individual to brush away from gum line, thereby providing a better cleaning of the teeth. The rotary brush head 118 spins about a horizontal axis via the pinion 124. Both the rotary brush head 118 and pinion 124 may be removably attached to the shaft 108.

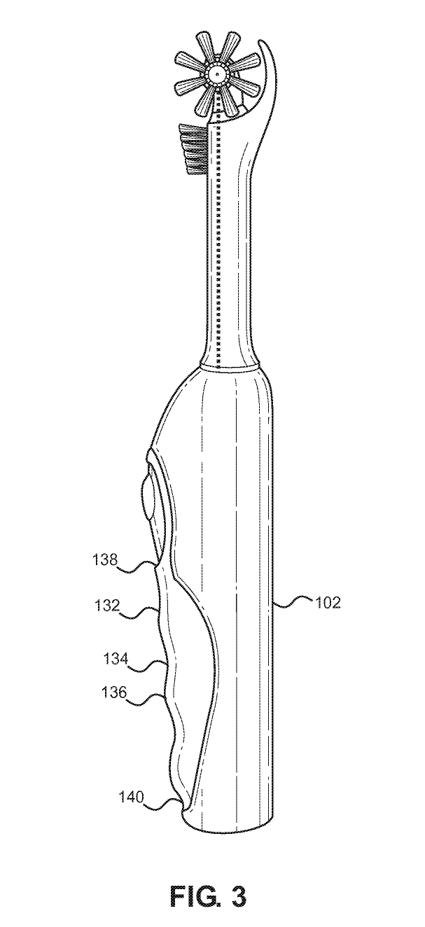

Referring now to FIG. 3, there is shown a side view of the electric rotary toothbrush according to one embodiment of the present invention. The electric rotary toothbrush may further include a handle portion 132 disposed on the housing 102. The handle portion 132 is preferably disposed on the front face of the housing 102. The handle portion 132 may have longitudinal concavities 134 defined by straight longitudinally extending raised side edges 136. The concavities 134 taper gradually and continuously in width from a head end 138 of the handle portion 132 to an opposite end 140 thereof. In a preferred embodiment, the handle portion 132 may be rotatable about the housing, thereby allowing a user to grasp the handle at different locations when the rotary brush head is angled in different directions.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An electric rotary toothbrush, comprising:
a housing;
an electric motor located within the housing, the electric motor includes a power rod, wherein the electric motor drives the power rod to provide a rotational force;
a shaft portion extending vertically from the housing, the shaft having a first end and a second end, the second end is removably mounted on the housing, wherein the first end comprises a curved tubular neck portion that tapers to a curved edge;
a rotary brush head rotatably mounted on the first end of the shaft, wherein the rotary brush head comprises a pinion and an annular ring having bristles extending radially around a periphery of the annular ring;
wherein the pinion is operably connected to the power rod to deliver the rotational force from the power shaft to the annular ring.

2. The electric rotary toothbrush of claim 1, wherein the shaft portion further comprises a rear gum guard.

3. The electric rotary toothbrush of claim 1, wherein the rotary brush head is rotatable via the pinion, wherein the pinion is removably attached to the first end of the shaft.

4. The electric rotary toothbrush of claim 1, wherein the electric motor provides at least three speed settings.

5. The electric rotary toothbrush of claim 4, wherein the speed settings are in a range of 100 to 500 revolutions per minute.

6. The electric rotary toothbrush of claim 1, further comprising an activation switch operably connected to the electric motor, wherein the activation switch is configured to turn the electric motor on or off.

7. The electric rotary toothbrush of claim 1, wherein the rotary brush head is adapted to pivot 90 degrees about the shaft.

8. The electric rotary toothbrush of claim 1, wherein the bristles of the rotary brush head spin end over end about the annular ring away from a user's gum line.

9. The electric rotary toothbrush of claim 1, wherein said electric motor is reversible.

10. The electric rotary toothbrush of claim 1, wherein the annular ring is removably connected to the pinion.

11. The electric rotary toothbrush of claim 1, wherein the rotary brush head spins about a horizontal axis.

12. The electric rotary toothbrush of claim 1, further comprising a handle portion disposed on the housing, the handle portion having longitudinal concavities defined by straight longitudinally extending raised side edges, the concavities tapering gradually and continuously in width from a head end of the handle portion to the opposite end thereof.

13. The electric rotary toothbrush of claim 1, wherein static bristles are integrally attached to the first end of the shaft.
